(19) United States
(12) Patent Application Publication
(10) Pub. No.: US 2026/0240114 A1
(43) Pub. Date: Aug. 20, 2026

(54) ILLUMINATED PET VEST AND METHOD THEREFOR

(71) Applicant: Calvin Garcia, Blythewood, SC (US)

(72) Inventor: Calvin Garcia, Blythewood, SC (US)

(21) Appl. No.: 19/058,821

(22) Filed: Feb. 20, 2025

(51) Int. Cl. A01K 13/00; A01K 11/00; G09F 9/33; G09F 21/02

(52) U.S. Cl. CPC A01K 13/006; G09F 9/33; G09F 21/023

(57) ABSTRACT

An illuminated pet vest includes a body portion that is designed to cover a torso of a pet. The body portion has a top side, a bottom side, a front end, and a rear end. The body portion includes a head opening at the front end. The body portion includes a plurality of leg openings at the bottom side. A fastener is designed to detachably secure the body portion around the pet. A light-emitting diode display is attached to the top side of the body portion. The light-emitting diode display is designed to display images. A microprocessor is connected to the light-emitting diode display to control operation thereof. A transceiver is connected to the microprocessor. The transceiver is designed to wirelessly receive images from a personal electronic device and transmit the images to the microprocessor to cause the light-emitting diode display to selectively display the images. A battery provides power.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet vests and more particularly pertains to a new illuminated pet vest for displaying images, including words and pictures, via a light-emitting diode (LED) display attached to a body portion of the pet vest, which body portion fits around a torso of a pet, such as a dog.

### (2) Description of Related Art Including Information Disclosed Under 37 CFR 1.97 and 1.98

The prior art relates to illuminated garments for pets and humans. The prior art, as best understood, does not disclose an illuminated pet vest for displaying images, including words and pictures, via a light-emitting diode display attached to a body portion of the pet vest, which light-emitting diode display is wirelessly programmable via a personal electronic device.

### BRIEF SUMMARY OF THE INVENTION

An embodiment of the disclosure meets the needs presented above in a illuminated pet vest generally comprising a body portion that is designed to cover a torso of a pet. The body portion has a top side, a bottom side, a front end, and a rear end. The body portion includes a head opening at the front end. The body portion includes a plurality of leg openings at the bottom side. A fastener is designed to detachably secure the body portion around the pet. A light-emitting diode display is attached to the top side of the body portion. The light-emitting diode display is designed to display images. A microprocessor is connected to the light-emitting diode display to control operation thereof. A transceiver is connected to the microprocessor. The transceiver is designed to wirelessly receive images from a personal electronic device and transmit the images to the microprocessor to cause the light-emitting diode display to selectively display the images. A battery is connected to the microprocessor, the transceiver, and the light-emitting diode display to provide power.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a illuminated pet vest according to an embodiment of the disclosure.

FIG. 2 is a bottom view of an embodiment of the disclosure.

FIG. 3 is a side view of an embodiment of the disclosure in use.

### DETAILED DESCRIPTION OF THE INVENTION

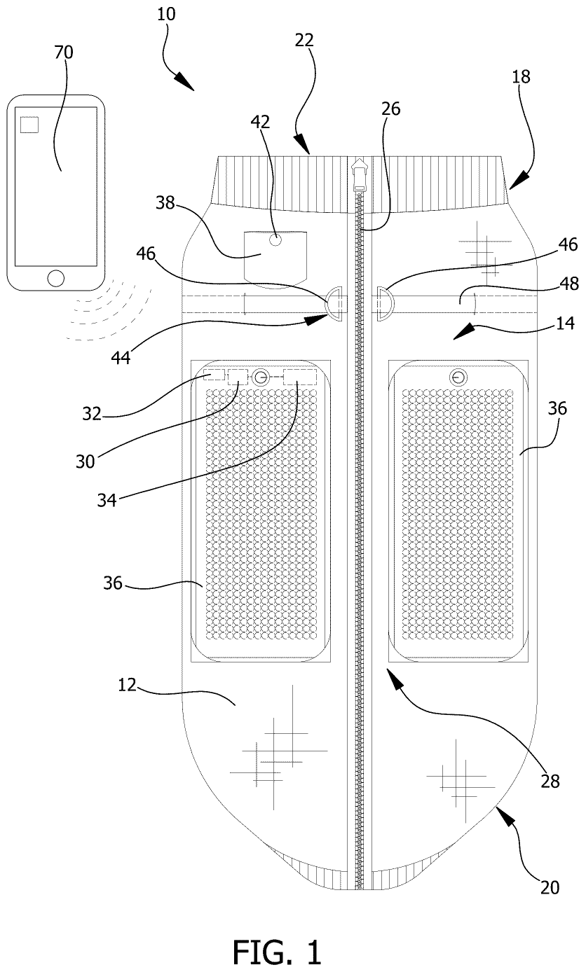

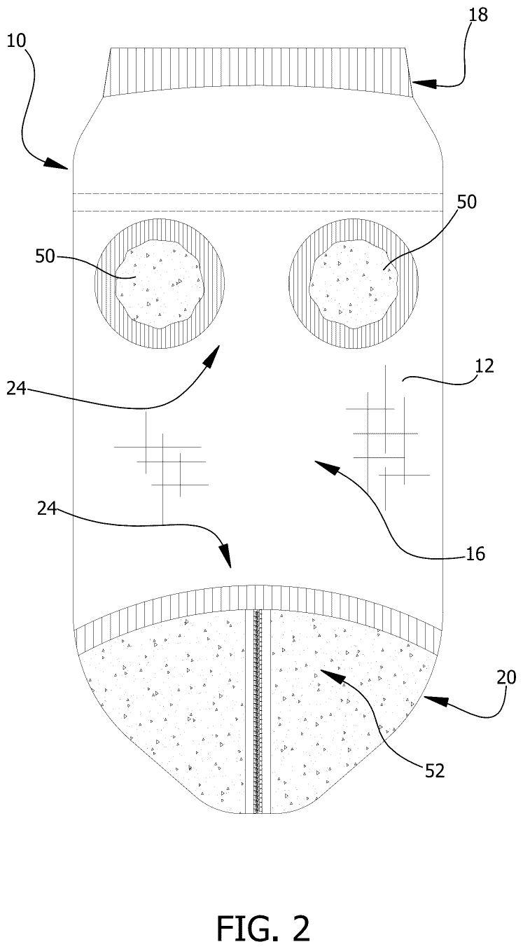

With reference now to the drawings, and in particular to FIGS. 1 through 3 thereof, a new illuminated pet vest embodying the principles and concepts of an embodiment of the disclosure and generally designated by the reference numeral 10 will be described.

As best illustrated in FIGS. 1 through 3, the illuminated pet vest 10 generally comprises a body portion 12 that is designed to cover a torso 62 of a pet 60. The body portion 12 has a top side 14, a bottom side 16, a front end 18, and a rear end 20. The body portion 12 includes a head opening 22 at the front end 18. The body portion 12 includes a plurality of leg openings 24 at the bottom side 16. A fastener 26 is designed to detachably secure the body portion 12 around the pet 60. A light-emitting diode display 28 is attached to the top side 14 of the body portion 12. The light-emitting diode display 28 is designed to display images. A microprocessor 30 is connected to the light-emitting diode display 28 to control operation thereof. A transceiver 32 is connected to the microprocessor 30. The transceiver 32 is designed to wirelessly receive images from a personal electronic device 70 and transmit the images to the microprocessor 30 to cause the light-emitting diode display 28 to selectively display the images. A battery 34 is connected to the microprocessor 30, the transceiver 32, and the light-emitting diode display 28 to provide power.

As shown in FIG. 1, the light-emitting diode display 28 includes a pair of light-emitting diode panels 36 positioned on the top side 14 of the body portion 12 with the fastener 26 between the light-emitting diode panels 36, such that each of the light-emitting diode panels 36 is positioned on a respective side of the torso 62 of the pet 60 when the body portion 12 is placed on the torso 62 of the pet 60.

The illuminated pet vest 10 also includes a pouch 38 attached to the body portion 12 and a GPS (global positioning system) tracking device 40 secured in the pouch 38.

The pouch 38 could include a snap 42 as shown in FIG. 1 to open and close the pouch 38. In one possible embodiment, the GPS tracking device 40 could be stitched or sealed in the pouch 38 to prevent loss or tampering. An example of a tracking device that could be used is the AirTag manufactured by Apple.

The fastener 26 is a zipper extending along the body portion 12 from the front end 18 to the rear end 20. Other fasteners, such as clips, buttons, clasps, and hook and loop material, could be used instead of the zipper in one possible embodiment.

The illuminated pet vest 10 also includes a leash attachment 44 that is positioned on the top side 14 of the body portion 12. In the exemplary embodiment in FIG. 1, the leash attachment 44 includes a pair of metal D-rings 46 and a reinforcement strap 48 extending around the top side 14 and the bottom side 16 of the body portion 12. A snap fit clip could also be utilized.

The leg openings 24 include a pair of front leg openings 50 positioned in the bottom side 16 of the body portion 12. Each of the front leg openings 50 is designed to receive a respective front leg 64 of the pet 60 passed therethrough. The leg openings 24 also include a rear leg opening 52 positioned at the rear end 20 of the body portion 12. The rear leg opening 52 is designed to receive both rear legs 66 and tail end 68 of the pet 60 passed therethrough.

In the exemplary embodiment, the body portion 12 is made of a soft fabric material, such as a textile, cotton, polyester, or a blend. In one possible embodiment, the body portion 12 is made of a weather-resistant outer layer, such as nylon, with padding inside.

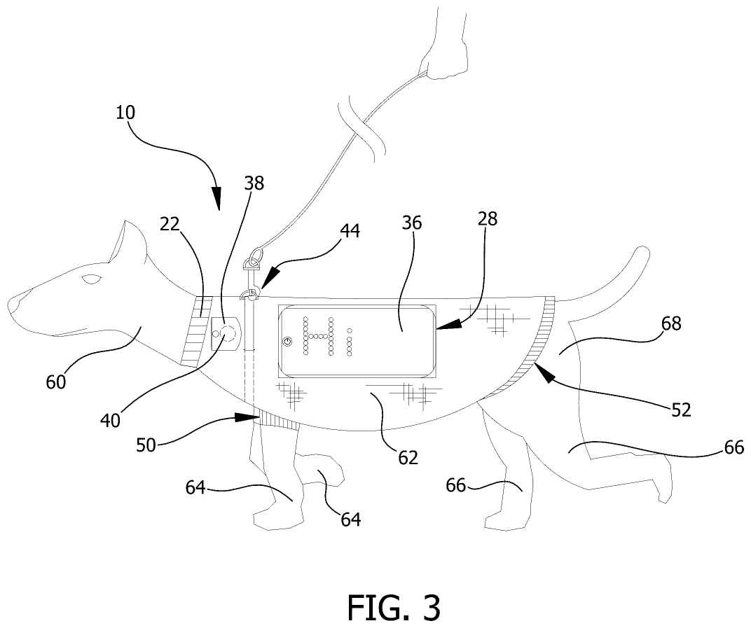

The illuminated pet vest 10 can be used to both track the location of the pet 60 using the GPS tracking device 40 and display images on the light-emitting diode display 28. The user places the body portion 12 on the torso 62 of the pet 60, such as a dog as shown in FIG. 3, though the body portion 12 could be configured for most any pet 60, such as a cat, a pig, or other animal. The user accesses a computer application on a personal electronic device 70, such as a smartphone as shown in FIG. 1. The user then inputs an image to be displayed on the light-emitting diode display 28, such as by selecting the image from a predetermined set of images or manually inputting an image. The image is then wirelessly transmitted via the transceiver 32 to the microprocessor 30 to display the image on the light-emitting diode display 28. The image could be one or more pictures, one or more alphanumeric characters, or a combination thereof, in virtually limitless varieties. For example, the user could input words and messages, such as entertaining messages, like “hi” or “have a great day,” or instructive messages, like “service dog” or “if found, call . . . .” The user could also input pictures, such as photos of family members, humorous images, or decorative scenes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated pet vest comprising:
a body portion being configured to cover a torso of a pet, said body portion having a top side, a bottom side, a front end, and a rear end, said body portion including a head opening at said front end, said body portion including a plurality of leg openings at said bottom side;
a fastener being configured to detachably secure said body portion around the pet, wherein said fastener is a zipper extending along said body portion from said front end to said rear end such that said fastener is configured to extend along a back of the pet aligned with a spine of the pet;
a light-emitting diode display being attached to said top side of said body portion, said light-emitting diode display being configured to display images, wherein said light-emitting diode display includes a pair of light-emitting diode panels positioned on said top side of said body portion with said fastener between said light-emitting diode panels, such that each of said light-emitting diode panels is positioned on a respective side of the torso of the pet when said body portion is placed on the torso of the pet;
a microprocessor being connected to said light-emitting diode display to control operation thereof;
a transceiver being connected to said microprocessor, said transceiver being configured to wirelessly receive images from a personal electronic device and transmit the images to said microprocessor to cause said light-emitting diode display to selectively display the images; and
a battery being connected to said microprocessor, said transceiver, and said light-emitting diode display to provide power.

2. (canceled)

3. The illuminated pet vest of claim 1, further comprising a pouch being attached to said body portion and a GPS tracking device being secured in said pouch.

4. (canceled)

5. The illuminated pet vest of claim 1, further comprising a leash attachment being positioned on said top side of said body portion.

6. The illuminated pet vest of claim 5, wherein said leash attachment comprises a pair of metal D-rings and a reinforcement strap extending around said top side and said bottom side of said body portion.

7. The illuminated pet vest of claim 1, wherein:
said leg openings include a pair of front leg openings positioned in said bottom side of said body portion;
each of said front leg openings is configured to receive a respective front leg of the pet passed therethrough;
said leg openings include a rear leg opening positioned at said rear end of said body portion; and
said rear leg opening is configured to receive both rear legs and tail end of the pet passed therethrough.

8. The illuminated pet vest of claim 1, wherein said body portion includes a soft fabric material.

9. (canceled)

10. (canceled)

11. The illuminated pet vest of claim 9, further comprising leash attachment being positioned on said top side of said body portion.

12. The illuminated pet vest of claim 11, wherein said leash attachment comprises a pair of metal D-rings and a reinforcement strap extending around said top side and said bottom side of said body portion.

13. The illuminated pet vest of claim 12, wherein:
said leg openings include a pair of front leg openings positioned in said bottom side of said body portion;
each of said front leg openings is configured to receive a respective front leg of the pet passed therethrough;
said leg openings include a rear leg opening positioned at said rear end of said body portion; and
said rear leg opening is configured to receive both rear legs and tail end of the pet passed therethrough.

14. The illuminated pet vest of claim 13, wherein said body portion includes a soft fabric material.

15. (canceled)

16. (canceled)
